(19) United States
(12) Patent Application Publication
(10) Pub. No.: US 2018/0276458 A1
(43) Pub. Date: Sep. 27, 2018

(54) INFORMATION PROCESSING DEVICE, METHOD AND STORAGE MEDIUM

(71) Applicant: KABUSHIKI KAISHA TOSHIBA, Minato-ku (JP)

(72) Inventors: Tomokazu KAWAHARA, Yokohama (JP); Masayuki MARUYAMA, Tokyo (JP); Shihomi TAKAHASHI, Yokohama (JP); Hideo UMEKI, Yokohama (JP)

(73) Assignee: KABUSHIKI KAISHA TOSHIBA, Minato-ku (JP)

(21) Appl. No.: 15/694,400

(22) Filed: Sep. 1, 2017

(30) Foreign Application Priority Data
Mar. 22, 2017 (JP) 2017-055365

(51) Int. Cl. G06K 9/00; G06T 7/70; H04N 5/232

(52) U.S. Cl. CPC G06K 9/00362; G06T 7/70; G06T 2207/30242; G06T 2207/30196; H04N 5/23293

(57) ABSTRACT

According to one embodiment, an information processing device includes a storage device and a processor connected to the storage device. The processor is configured to perform a process for displaying a first image and information indicating a partial area of the first image, acquire information related to a target in the partial area, and detect a target from at least one of the first image and a second image different from the first image based on the information related to the target.

### CROSS-REFERENCE TO RELATED APPLICATIONS

This application is based upon and claims the benefit of priority from Japanese Patent Application No. 2017-055365, filed Mar. 22, 2017, the entire contents of which are incorporated herein by reference.

### FIELD

Embodiments described herein relate generally to an information processing device, a method and a storage medium.

### BACKGROUND

In recent years, for example, an information processing device (hereinafter, referred to as a target detection device) capable of detecting the target from the image (for example, the moving image) captured by an imaging device (camera) such as a security camera has been known.

The target detection device is capable of obtaining the number of targets (for example, people), etc., moving in the area which can be captured by the camera. Thus, for example, the degree of congestion in the area can be determined.

In the target detection device, parameters which allow the device to accurately detect the target included in an image are set in advance.

However, in some cases, the target detection device cannot appropriately detect the target because of the installation position or environment of the camera, etc.

In such a case, the parameters set in the target detection device need to be adjusted. However, it is difficult for the user of the target detection device (in other words, the company into which the device has been introduced) to adjust (change) the parameters.

A mechanism which allows the accurate detection of the target without any difficult adjustment of the parameters is demanded.

### BRIEF DESCRIPTION OF THE DRAWINGS

FIG. 1 is a block diagram showing an example of the configuration of a target detection device according to a first embodiment.

FIG. 2 is shown for explaining an example of the installation position of a camera.

FIG. 3 shows an example of the image captured by the camera.

FIG. 4 shows another example of the image captured by the camera.

FIG. 5 shows an example of the result of detection of a human detection process for the image shown in FIG. 3.

FIG. 6 shows an example of the result of detection of a human detection process for the image shown in FIG. 4.

FIG. 7 is a flowchart showing an example of the procedure of a parameter adjustment process.

FIG. 8 shows an example of the image and a visual confirmation range displayed on a display.

FIG. 9 shows an example of a visual confirmation range different from that of FIG. 8.

FIG. 10 is shown for explaining a parameter adjustment process in a case where detection unnecessary people are specified based on the size.

FIG. 11 is shown for explaining a parameter adjustment process in a case where detection unnecessary people are specified based on the brightness or contrast.

FIG. 12 is shown for explaining a parameter adjustment process in a case where detection unnecessary people are specified based on the position.

FIG. 13 shows an example of a setting screen for setting modes.

FIG. 14 is a block diagram showing an example of the configuration of a target detection device according to a second embodiment.

FIG. 15 is a flowchart showing an example of the procedure of a parameter adjustment process.

FIG. 16 shows an example of an adjustment screen.

### DETAILED DESCRIPTION

In general, according to one embodiment, an information processing device includes a storage device and a processor connected to the storage device. The processor is configured to perform a process for displaying a first image and information indicating a partial area of the first image, acquire information related to a target in the partial area, and detect a target from at least one of the first image and a second image different from the first image based on the information related to the target.

Various embodiments will be described hereinafter with reference to the accompanying drawings.

### First Embodiment

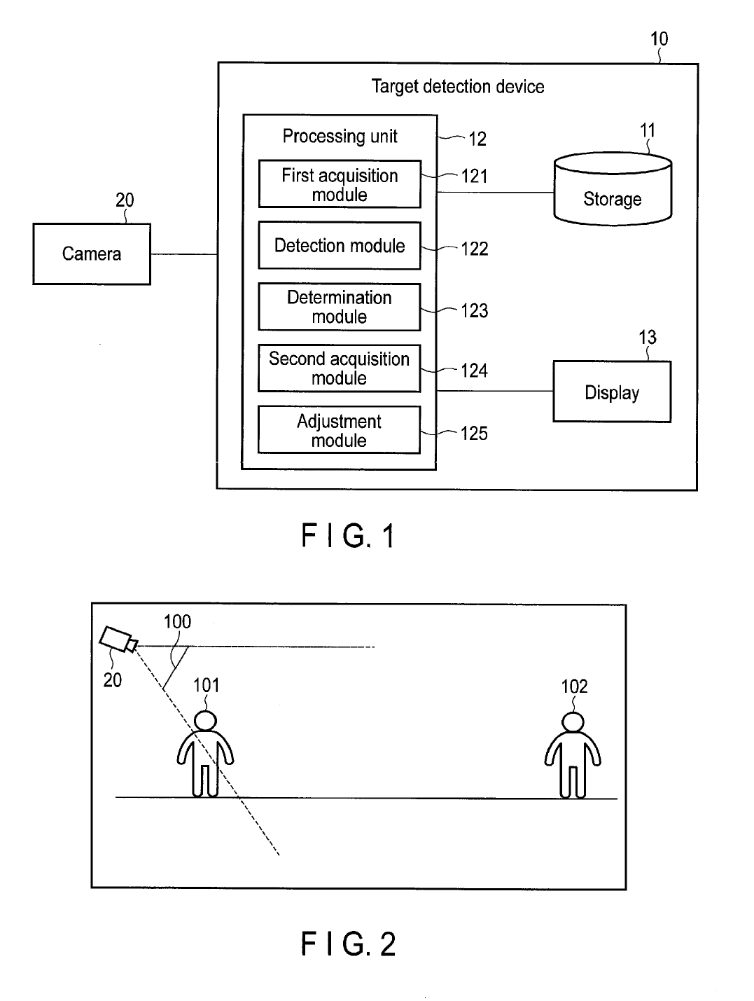

FIG. 1 is a block diagram showing an example of the configuration of an information processing device according to a first embodiment. The information processing device of the present embodiment is realized as a target detection device capable of detecting the target from an image. In the following description, the information processing device of the present embodiment is explained as a target detection device.

As shown in FIG. 1, a target detection device 10 is connected to a camera 20. As shown in, for example, FIG. 2, the camera 20 is installed at a high position such that a predetermined area (hereinafter, referred to as a capture area) which is relatively wide is included in the angle of view. In this way, the camera 20 is capable of capturing an image including a plurality of targets moving in the capture area, such as people. Hereinafter, this specification assumes that the target to be detected is a person.

The straight line 100 shown in FIG. 2 indicates the plane of the image captured by the camera 20. When an image is captured by the camera 20 installed at the position shown in FIG. 2, a person 101 present at a position close to the camera 20 appears on the lower side of the image in a relatively large size. A person 102 present at a position far from the camera 20 appears on the upper side of the image in a relatively small size. The size and position of each person appearing in the image are determined based on the installation height (the height of the camera), the angle of view, the angle of depression, the size of the image of the camera 20, etc.

The target detection device 10 of the present embodiment is used to detect each person (target) included in the image captured by the camera 20 (in other words, to perform an image recognition process). The result of human detection obtained by the target detection device 10 may be used for, for example, the detection of the degree of congestion of people in a predetermined area (for example, a facility) including the above capture area.

The target detection device 10 of the present embodiment includes a storage 11, a processing unit 12 and a display 13. In the present embodiment, the storage 11 is realized by a storage device and a memory device provided in the target detection device 10, such as a hard disk drive (HDD), a solid state drive (SSD), a read only memory (ROM) or a random access memory (RAM). The processing unit 12 is realized by a computer provided in the target detection device 10 and executing a program stored in the storage device or the memory device. The processing unit 12 includes a processor and the like connected to the storage device and the memory device. The display 13 is realized by a display device provided in the target detection device 10, such as a liquid crystal display, an organic electroluminescent display or a touchpanel display.

A setting file in which parameters used to detect each person included in an image as described above (in other words, parameters related to human detection) are set is stored in the storage 11. In the setting file, for example, parameters (values) for accurately detecting people when the camera 20 is installed at an appropriate position are set in advance.

In the present embodiment, the processing unit 12 performs a process for detecting each person included in an image as described above. The processing unit 12 performs a process for adjusting the above parameters used to detect people.

The processing unit 12 includes a first acquisition module 121, a detection module 122, a determination module 123, a second acquisition module 124 and an adjustment module 125. The modules 121 to 125 included in the processing unit 12 are partially or entirely realized by causing the above computer to execute a program, in other words, by software. The modules 121 to 125 may be partially or entirely realized by hardware such as an integrated circuit (IC), or may be realized as a structure obtained by combining software and hardware. The program executed by the computer may be stored in a computer-readable storage medium and distributed. Alternatively, the program may be downloaded into the target detection device 10 via a network.

The first acquisition module 121 acquires the image captured by the camera 20. For example, the image captured by the camera 20 may be stored in the storage 11. In this case, the first acquisition module 121 is capable of acquiring an image from the storage 11. The first acquisition module 121 may acquire an image from, for example, a server device provided outside the target detection module 10.

The detection module 122 detects more than one person included in the image acquired by the first acquisition module 121 in accordance with the parameters set in the setting file. The parameters set in the setting file include, for example, a parameter (a detection size parameter) related to the size of the people to be detected from images.

The determination module 123 determines a specific range (hereinafter, referred to as a visual confirmation range) in the image acquired by the first acquisition module 121. For example, the determination module 123 determines a visual confirmation range (a partial area of the image) including at least one of the people detected by the detection module 122.

The first acquisition module 121 and the determination module 123 function as a display processor which transmits the image acquired by the first acquisition module 121 and the visual confirmation range determined by the determination module 123 (in other words, information indicating a partial area of the image) to the display 13 and displays the image and the visual confirmation range on the display 13. In this manner, the user (operator) of the target detection device 10 is able to visually confirm the image (specifically, the visual confirmation range of the image) displayed on the display 13.

The second acquisition module 124 acquires information related to the people included in the visual confirmation range of the image visually confirmed by the user in the above manner (hereinafter, referred to as visual confirmation information). The visual confirmation information acquired by the second acquisition module 124 includes, for example, the number of people included in the visual confirmation range visually confirmed by the user. For example, the number of people included in the visual confirmation information is specified (input) by the user.

Based on the result of human detection by the detection module 122 (in other words, the number of people included in the image detected by the detection module 122) and the visual confirmation information acquired by the second acquisition module 124 (in other words, the number of people included in the visual confirmation information), the adjustment module 125 adjusts (determines) the parameters set in the setting file.

When the parameters are adjusted by the adjustment module 125, the detection module 122 is capable of performing a process for detecting people in accordance with the adjusted parameters. The detection module 122 detects the people included in the image based on the above visual confirmation information (in other words, information related to people). In this case, the detection module 122 may detect people from an image (a first image) already acquired by the first acquisition module 121 or detect people from another image (a second image) acquired after the first image, based on the information related to people.

Now, the behavior of the target detection module 10 of the present embodiment is explained. The target detection device 10 of the present embodiment is capable of applying an image recognition process to the image (for example, the moving image) captured by the camera 20 and detecting more than one person included in the image as described above. In this case, the target detection device 10 is capable of extracting an area in which the likelihood of a person is high from the image, and detecting the person. A known technology may be used to detect people from images. For example, the technology disclosed in JP 2016-095640 A may be used.

A process for detecting people from images (hereinafter, referred to as a human detection process) is performed in accordance with the above parameters set in the setting file. The parameters include the above detection size parameter. As the detection size parameter, the upper limit (value) and the lower limit (value) of the size of the people to be detected are defined. According to the detection size parameter, the detectability of a person in a size applicable between the upper and lower limits is high (in other words, such a person is easily detected). Further, the detectability of a person in a size greater than the upper limit or less than the lower limit is low (in other words, such a person is hardly detected).

The above parameter is set in advance to the extent that people can be accurately detected.

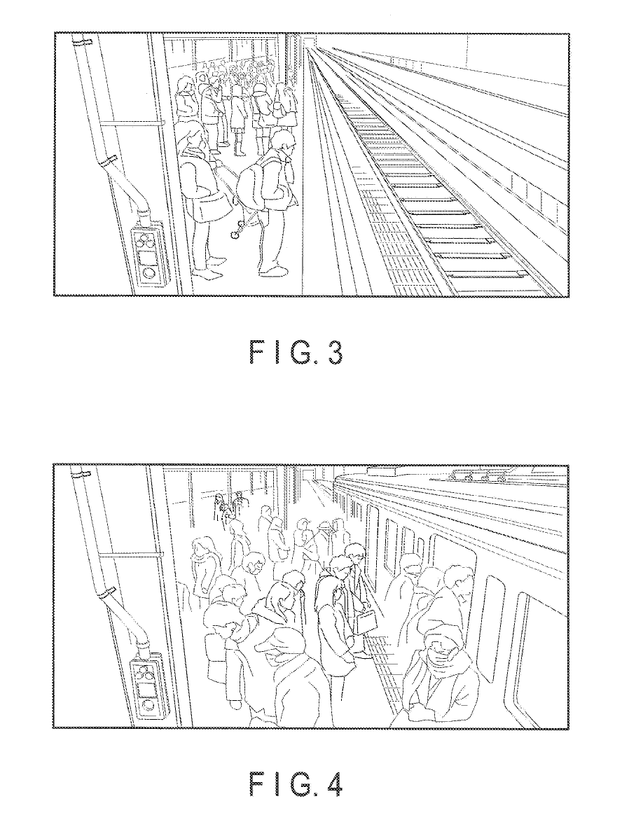

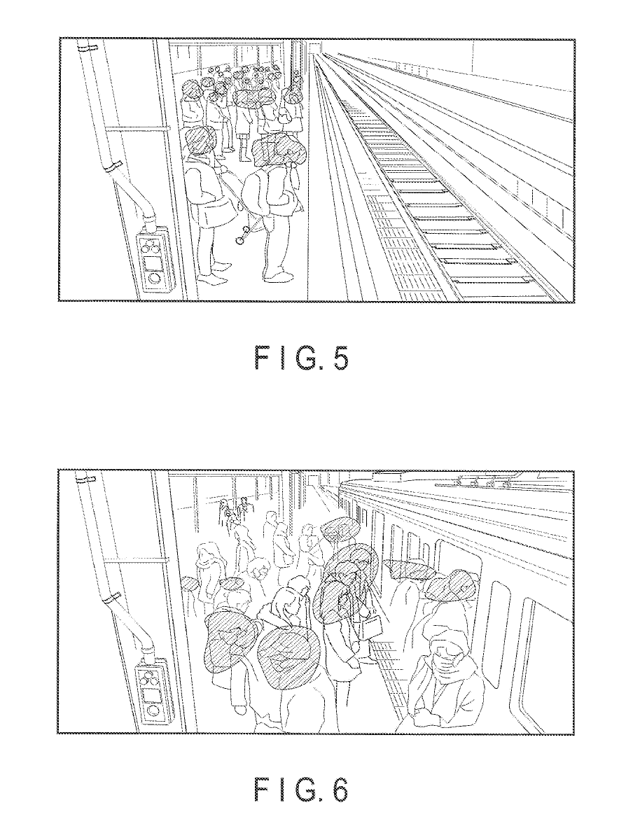

FIG. 3 and FIG. 4 show examples of the images captured by the camera 20 in different time periods. FIG. 3 and FIG. 4 assume that the camera 20 is installed on a train platform. FIG. 5 shows an example of the result of human detection when a human detection process is applied to the image shown in FIG. 3. FIG. 6 shows an example of the result of human detection when a human detection process is applied to the image shown in FIG. 4. FIG. 5 and FIG. 6 show examples of the results of detection for the heads of people. In the results of detection shown in FIG. 5 and FIG. 6, a specific color (for example, red or yellow) is applied to an area corresponding to each person (specifically, the head of each person) detected by a human detection process.

In the example shown in FIG. 5, the specific color is applied to most of the areas corresponding to the heads of the people included in the image shown in FIG. 3. Thus, FIG. 5 shows an example of the result of detection in which the accuracy is relatively high.

The example shown in FIG. 6 includes a great number of people who are not colored with the specific color in their heads. Thus, FIG. 6 shows an example of the result of detection in which the accuracy is relatively low.

As shown in FIG. 3 and FIG. 4, because of the installation position of the camera 20, in the image captured by the camera 20, the size of the people located on the upper side is small, and the size of the people located on the lower side is large. Thus, the detection size parameter differs (specifically, the upper and lower limits of the detection size parameter differ) between the upper area and the lower area of the image. The areas for which different values are set are not limited to the upper and lower areas. Thus, the number of areas for which different values are set is not limited to two, and may be three or more.

For example, even when the parameters are set in the setting file as described above, in some cases, people cannot be appropriately (accurately) detected because of the installation position or environment of the camera 20.

In this case, the parameters set in the setting file need to be adjusted (changed) in accordance with the installation position or environment of the camera 20.

The target detection device 10 of the present embodiment performs a process for automatically adjusting the parameters used to detect people (hereinafter, referred to as a parameter adjustment process).

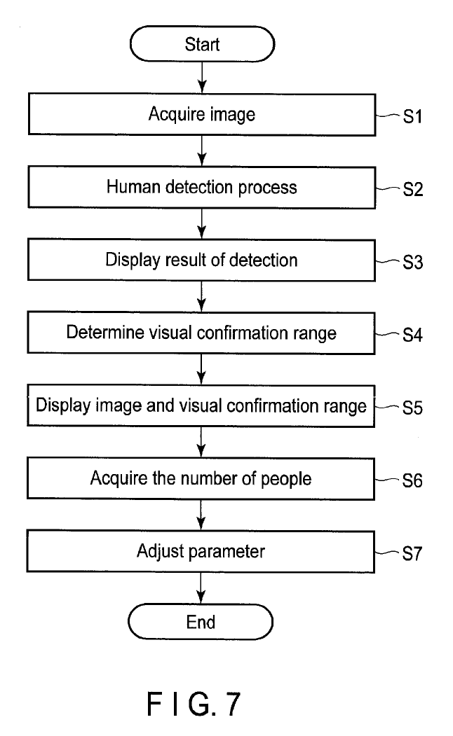

This specification explains an example of the procedure of a parameter adjustment process with reference to the flowchart of FIG. 7. Here, this specification mainly explains a process for adjusting the detection size parameter (hereinafter, referred to as a first parameter adjustment process). For example, the process shown in FIG. 7 is performed when the user of the target detection device 10 instructs the device to perform the first parameter adjustment process.

The first acquisition module 121 acquires the image captured by the camera 20 (step S1). The image captured by the first acquisition module 121 includes the image (for example, the still image) captured by the camera 20 when the user instructs the device to perform the first parameter adjustment process. For example, the first acquisition module 121 may acquire the image specified by the user from the images stored in the storage 11 (for example, from the images constituting a past moving image), or may acquire an image automatically selected from the images in the target detection device 10. When an image is automatically selected, the target detection device 10 selects, for example, an image including more than one person.

Subsequently, the detection module 122 applies a human detection process to the image acquired in step S1, and detects more than one person from the image (step S2). The human detection process is performed in accordance with the parameters (the detection size parameter, etc.,) set in the setting file as described above. As the human detection process is explained above, the detailed description thereof is omitted here.

The result of detection of step S2 is displayed on the display 13 (step S3). In this case, the result of detection is displayed on the display 13 in the form explained with reference to FIG. 5 and FIG. 6. In this way, the user is able to confirm the validity (accuracy) of the result of human detection for the image acquired in step S1.

The determination module 123 determines a specific range (visual confirmation range) in the image acquired in step S1 (step S4). The visual confirmation range is used to allow the user to input (specify) the number of people present in the visual confirmation range.

In step S4, the determination module 123 is capable of determining, for example, one of the following first to fourth ranges as the visual confirmation range.

The first range includes, for example, the range specified by the user in the image. Specifically, the first range may be the range identified by the position, shape and size specified by the user, or may be a certain range including the position specified by the user in the image.

The second range includes, for example, a range equivalent to one of a predetermined number of tile-shaped areas into which the area of the image is divided. The second range may be a range equivalent to an area randomly selected from the divisional tile-shaped areas, or may be a range equivalent to the area specified by the user from the divisional tile-shaped areas.

The third range includes, for example, a range randomly selected by the target detection device 10 (the determination module 123).

The fourth range includes, for example, a range including an area in which a person is presumably present in the image. In this case, an area in which a person is presumably present in the image may be identified by an image process such as background subtraction (or interframe differential technique). The fourth range may be a range including an area randomly selected from a plurality of areas in which a person is presumably present in the image, or may be a range including the area specified by the user from a plurality of areas in which a person is presumably present in the image. The fourth range may be a range including an area in which no person is presumably present (in other words, an area which does not include any person) in the image.

The first to fourth ranges explained above are merely examples. The determination module 123 may determine another range as the visual confirmation range. For example, as the visual confirmation range, the determination module 123 may determine (select) an area including a portion which seems to include a detected person in the image. The information of the likelihood of a person for each pixel constituting the image may be used to determine the visual confirmation range. The visual confirmation range may be, for example, a range equivalent to the whole image acquired in step S1.

After step S4 is performed, the image acquired in step S1 and the visual confirmation range determined in step S4 are displayed on the display 13 (step S5).

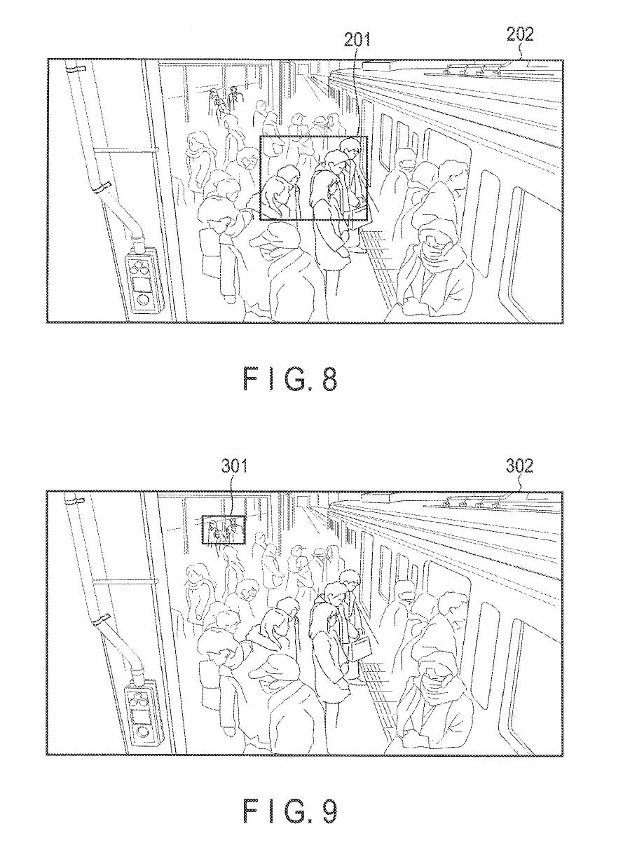

FIG. 8 shows an example of the image and visual confirmation range displayed on the display 13 in step S5. As shown in FIG. 8, the visual confirmation range is indicated with, for example, a rectangular frame 201. The rectangular frame (visual confirmation range) 201 is superimposed on an image 202.

In this case, for example, the user visually confirms (sees) the visual confirmation range in the image displayed on the display 13 and inputs visual confirmation information related to the people included in the visual confirmation range by operating the target detection device 10. The visual confirmation information includes the number of people included in the visual confirmation range (in other words, the number of people visually confirmed by the user). The visual confirmation information (the number of people) is input by the user with various input devices provided in the target detection device 10 (for example, a keyboard, mouse, touchpanel display, etc.,) although this explanation is omitted in FIG. 1, etc., above.

When the image 202 and the visual confirmation range 201 shown in FIG. 8 are displayed, the user inputs “5” as the number of people included in the visual confirmation range 201.

Returning to FIG. 7, the second acquisition module 124 acquires the number of people (visual confirmation information) input by the user (step S6).

Subsequently, the adjustment module 125 adjusts a parameter set in the setting file based on the result of detection of step S2 and the number of people acquired in step S6 (step S7).

Specifically, when the number of people detected in the visual confirmation range by the human detection process of step S2 (hereinafter, referred to as the number of detected people) is different from the number of people acquired in step S6 (hereinafter, referred to as the number of visually confirmed people), the adjustment module 125 adjusts a parameter (for example, the detection size parameter) such that the number of detected people is equal to the number of visually confirmed people. In this case, for example, the adjustment module 125 is capable of obtaining a parameter in which the number of detected people is equal to the number of visually confirmed people by repeating the adjustment of the parameter and a human detection process.

The parameter adjusted in step S7 is set again in the setting file. In other words, the existing parameter in the setting file is overwritten with the parameter adjusted in step S7.

When the set detection size parameter differs (in other words, the set values differ) between the upper area and the lower area of the image as described above, for example, the values of the areas are adjusted in connection with each other. Specifically, for example, even when the visual confirmation range is a range corresponding to the upper area of the image, the values of the upper area and the values of the lower area are adjusted in connection with each other (in the same way). For example, the target detection device 10 may be configured such that the parameter used to detect the people present outside an area corresponding to the visual confirmation range may be adjusted (determined).

In the above explanation, the different values of the detection size parameter of areas are adjusted in connection with each other. However, only the values of the detection size parameter of an area corresponding to the visual confirmation range (in other words, the area applicable to the visual confirmation range) may be independently adjusted.

When the number of detected people is equal to the number of visually confirmed people in step S7, there is no need to adjust the parameter. However, the number of detected people and the number of visually confirmed people in the visual confirmation range determined in step S4 may be equal by accident, and thus, the number of detected people and the number of visually confirmed people in another range may be different from each other. Even when the parameter is adjusted in step S7, the number of detected people and the number of visually confirmed people in a range other than the visual confirmation range determined in step S4 are not necessarily equal.

Therefore, although not shown in FIG. 7, for example, the process of steps S2 to S7 may be repeated a plurality of times. For example, when step S2 is performed after the adjustment of the parameter in step S7, a human detection process is performed in step S2 in accordance with the adjusted parameter. Further, when the process is repeated, a range different from the visual confirmation range determined in the previous round is determined in step S4. Specifically, for example, when the visual confirmation range shown in FIG. 8 (specifically, the range indicated with the rectangular frame 201) is determined in step S4 in the first round, for example, the range indicated with the rectangular frame 301 shown in FIG. 9 is determined as the visual confirmation range in step S4 in the second round. When the visual confirmation range shown in FIG. 9 is displayed (specifically, the visual confirmation range and the image shown in FIG. 9 are displayed), “3” is acquired as the number of visually confirmed people in step S6.

The density of people preferably differs between the visual confirmation range determined in step S4 in the first round and the visual confirmation range determined in step S4 in the second round. Specifically, for example, the visual confirmation range in which the density is high is determined in step S4 in the first round. The visual confirmation range in which the density is low is determined in step S4 in the second round. In this structure, the number of detected people and the number of visually confirmed people can be equal in a visual confirmation range in which the density is high and a visual confirmation range in which the density is low with a small number of repeated rounds. Thus, the processing amount can be reduced. The density (the number of people) in the visual confirmation range determined in step S4 is preferably moderate. Thus, for example, the visual confirmation range may be determined such that the density is within a predetermined range.

Further, for example, the visual confirmation range may be determined from the lower area of the image in step S4 in the first round, and the visual confirmation range may be determined from the upper area of the image in step S4 in the second round.

The process of steps S2 to S7 is repeated as described above, and therefore the parameter can be adjusted such that the number of detected people and the number of visually confirmed people are equal in a plurality of ranges (visual confirmation ranges) in the image.

When the process of steps S2 to S7 is repeated, for example, the first parameter adjustment process is terminated after the process is repeated a predetermined number of times.

Alternatively, the user may confirm the result of detection displayed in step S3 in each round. When the user presses (specifies) a button, etc., provided on the display screen of the result of detection for instructing the device to terminate the process, the first parameter adjustment process may be terminated. For example, the user is able to press the button for instructing the device to terminate the process when the user confirms the result of detection and determines that the result of detection (specifically, the accuracy) is improved.

Alternatively, for example, the first parameter adjustment process may be terminated when the number of detected people is successively equal to the number of visually confirmed people a predetermined number of times.

When the process of steps S2 to S7 is repeated as described above, the parameter should be adjusted in step S7 such that at least the difference between the number of detected people and the number of visually confirmed people is small. In this case, when the difference between the number of detected people and the number of visually confirmed people reaches a predetermined value after the process of steps S2 to S7 is repeated, the process may be terminated. In this structure, there is no need to adjust the parameter to the extent that the number of detected people is equal to the number of visually confirmed people in step S7. Thus, the amount of calculation in step S7 can be reduced.

In the above explanation, the process of steps S2 to S7 is repeated. However, as explained with reference to FIG. 7 above, the first parameter adjustment process may be terminated without repeating the process of steps S2 to S7.

In the above explanation, the result of detection is displayed in step S3 for the confirmation by the user. However, when the confirmation by the user is unnecessary, step S3 may be omitted.

According to the first parameter adjustment process described above, the accuracy of human detection can be improved in the target detection device 10 by adjusting the detection size parameter. However, in some cases, an unnecessary person for the user may be detected from the image. In the target detection device 10 of the present embodiment, a process for adjusting a parameter related to people who should not be detected (hereinafter, referred to as detection unnecessary people) may be further performed.

This specification explains an example of the procedure of a process for adjusting a parameter related to detection unnecessary people (hereinafter, referred to as a second parameter adjustment process).

For example, the second parameter adjustment process is performed when the user of the target detection device 10 instructs the device to perform the second parameter adjustment process. For example, the second parameter adjustment process is performed after the first parameter adjustment process described above is performed.

Here, the second parameter adjustment process is explained with reference to the flowchart of FIG. 7 for the sake of convenience. Structures different from those of the first parameter adjustment process are mainly explained.

In the second parameter adjustment process, the process of steps S1 to S5 described above is performed.

Subsequently, for example, the user visually confirms the visual confirmation range in the image displayed on the display 13 and inputs visual confirmation information related to the people included in the visual confirmation range by operating the target detection device 10. In the first parameter adjustment process, the number of people included in the visual confirmation range is input as the visual confirmation information. However, in the second parameter adjustment process, of the people included in the visual confirmation range, the desired number of people who should be detected in the human detection process is input by the user.

In this way, the second acquisition module 124 acquires the number of people (visual confirmation information) input by the user (step S6). For example, when five people are present in the visual confirmation range displayed in step S5, and further when the desired number of people who should be detected in the human detection process is three of the five people, the second acquisition module 124 acquires “3” input by the user.

Subsequently, the adjustment module 125 adjusts (sets) the parameter related to detection unnecessary people described above based on the result of detection of step S2 and the number of people acquired in step S6 (step S7).

Specifically, when the number of people detected in the visual confirmation range by the human detection process in step S2 (in other words, the number of detected people) is different from the number of people acquired in step S6 (hereinafter, referred to as the desired number of people to be detected), for example, the adjustment module 125 specifies detection unnecessary people from the people detected in the visual confirmation range.

In this case, the adjustment module 125 is capable of specifying people having a small size as detection unnecessary people from the people detected in the visual confirmation range. Specifically, when the number of detected people is five, and the desired number of people to be detected is three, two people in a size smaller than the other people are specified as detection unnecessary people.

The adjustment module 125 adjusts the parameter related to detection unnecessary people such that the detection unnecessary people specified based on the size of each person in the above manner are not detected in the visual confirmation range. Specifically, the adjustment module 125 adjusts the detection size parameter (specifically, the lower limit defined in the detection size parameter) to the extent that detection unnecessary people are not detected in the visual confirmation range. The parameter related to detection unnecessary people may be the detection size parameter.

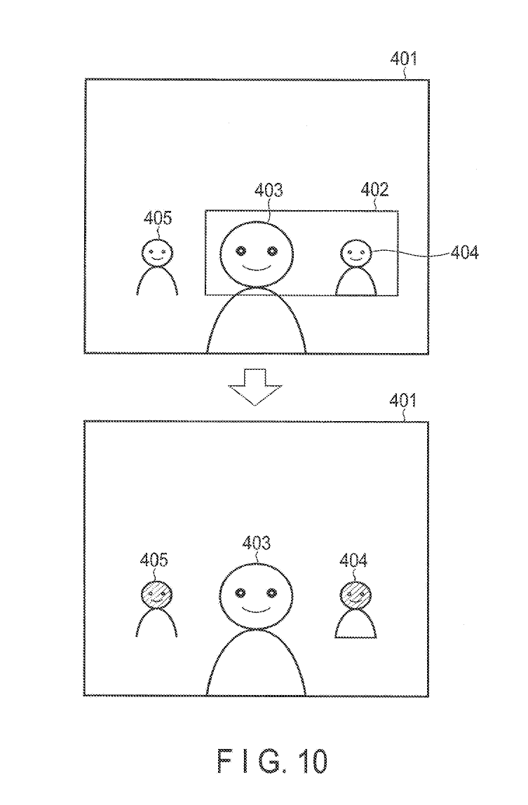

Referring to FIG. 10, this specification specifically explains the second parameter adjustment process in a case where detection unnecessary people are specified based on the size of each person as described above. In FIG. 10, for the sake of convenience, the background is omitted, and people are schematically illustrated in comparison with FIG. 8 and FIG. 9 explained above.

It is assumed that an image 401 and a visual confirmation range 402 are displayed in the second parameter adjustment process.

As shown in the upper stage of FIG. 10, a person 403 present at a position close to the camera 20 (that is, a person 403 in a large size) and a person 404 present at a position far from the camera 20 (that is, a person 404 in a small size) may nearly appear on the image 401 depending on the installation position of the camera 20, etc. It is assumed that the visual confirmation range 402 includes the people 403 and 404 in different sizes.

For example, when the user considers that the detection of the person 404 in a small size is unnecessary, the user specifies a mode for setting the lower limit of the size and inputs “1” as the desired number of people to be detected. In this case, of the people 403 and 404 detected in the visual confirmation range 402, the person 404 in a small size is specified as a detection unnecessary person. In this way, the detection size parameter (a parameter related to detection unnecessary people) is adjusted such that the person 404 specified as a detection unnecessary person is not detected. Specifically, the detection size parameter is adjusted such that the lower limit defined in the detection size parameter is greater than the size of the person 404. The mode for setting the lower limit of the size is a mode for adjusting (setting) the lower limit defined in the detection size parameter.

When a human detection process is applied to the image 401 after the above adjustment of the parameter, as shown in the lower stage of FIG. 10, the person 404 in a small size is not detected. A person 405 in a size similar to that of the person 404 is not detected in the image 401. In the lower stage of FIG. 10, hatching is applied to the people which are not detected by a human detection process after the adjustment of the parameter.

When detection unnecessary people are specified based on the size of people as described above, the parameter may be adjusted such that neither the person 404 nor the person 405 is detected based on the desired number of people to be detected input by the user.

In the above explanation, the lower limit defined in the detection size parameter is adjusted. However, when the upper limit defined in the detection size parameter is adjusted, the user specifies a mode for setting the upper limit of the size. In this manner, people in a large size are specified as detection unnecessary people, and the upper limit defined in the detection size parameter is adjusted such that the specified people are not detected.

Detection unnecessary people may be specified based on other conditions (standards). Specifically, for example, detection unnecessary people may be specified based on the brightness (luminance) or contrast ratio of an area corresponding to the people included in the visual confirmation range, or may be specified based on the positions of the people included in the visual confirmation range.

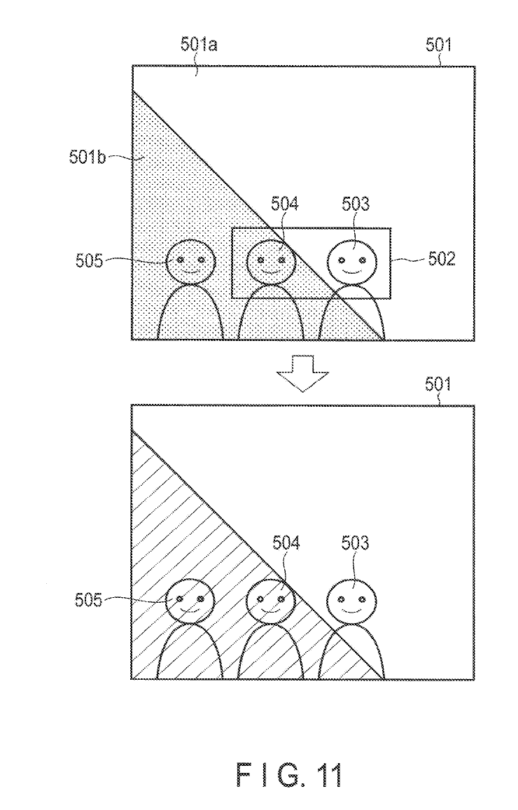

Now, this specification specifically explains the second parameter adjustment process in a case where detection unnecessary people are specified based on the brightness or contrast ratio of an area corresponding to people with reference to FIG. 11. In FIG. 11, for the sake of convenience, the background is omitted, and people are schematically illustrated in a manner similar to that of FIG. 10. In the following description, this specification mainly explains that detection unnecessary people are specified based on the brightness. However, the same explanation is applied to a case where detection unnecessary people are specified based on the contrast ratio.

It is assumed that an image 501 and a visual confirmation range 502 are displayed in the second parameter adjustment process.

As shown in the upper stage of FIG. 11, the brightness may differ between the areas of the image 501 depending on the installation position or environment of the camera 20, etc. In the upper stage of FIG. 11, an area 501a of the image 501 is an area in which the brightness is high (greater than or equal to a threshold). An area 501b is an area in which the brightness is low (less than the threshold). It is assumed that the visual confirmation range 502 includes a person 503 corresponding to (located in) the area 501a and a person 504 corresponding to (located in) the area 501b.

For example, when the user considers that the detection of the person 504 located in the area 501b in which the brightness is low is unnecessary, the user specifies a mode for setting the lower limit of the brightness and inputs “1” as the desired number of people to be detected. In this case, of the people 503 and 504 detected in the visual confirmation range 502, the person 504 corresponding to the area 501b in which the brightness is low is specified as a detection unnecessary person. In this way, for example, the parameter related to the brightness of (an area corresponding to) the people to be detected from images (in other words, a parameter related to detection unnecessary people) is adjusted such that the person 504 specified as a detection unnecessary person is not detected.

In the parameter related to the brightness of the people to be detected from images (hereinafter, referred to as a detection brightness parameter), the upper and lower limits of the brightness are defined. According to the detection brightness parameter, the detectability of a person corresponding to an area having a brightness applicable between the upper and lower limits is high (in other words, such a person is easily detected). The detectability of a person corresponding to an area having a brightness greater than the upper limit or lower than the lower limit is low (in other words, such a person is hardly detected).

In this case, the detection brightness parameter is adjusted such that the lower limit defined in the detection brightness parameter (in other words, the lower limit of the brightness) is greater than the brightness of the area 501b.

The mode for setting the lower limit of the brightness is a mode for adjusting (setting) the lower limit defined in the detection brightness parameter.

When a human detection process is applied to the image 501 after the above adjustment of the parameter, as shown in the lower stage of FIG. 11, the person 504 present in the area 501b is not detected. In addition, a person 505 present in the area 501b is not detected. In the lower stage of FIG. 11, hatching is applied to the area 501b in which people are not detected by a human detection process after the adjustment of the parameter.

When detection unnecessary people are specified based on the brightness of an area corresponding to people, the parameter may be adjusted such that neither the person 504 nor the person 505 is detected based on the desired number of people to be detected input by the user. In other words, an area having a low brightness such as an area corresponding to the people 504 and 505 can be excluded from the target area of a human detection process (in other words, the area from which people are detected) by adjusting the detection brightness parameter as described above.

In the above explanation, the lower limit defined in the detection brightness parameter is adjusted. However, when the upper limit defined in the detection brightness parameter is adjusted, the user specifies a mode for setting the upper limit of the brightness. In this manner, people corresponding to an area in which the brightness is high are specified as detection unnecessary people, and the upper limit defined in the detection brightness parameter is adjusted such that the specified people are not detected.

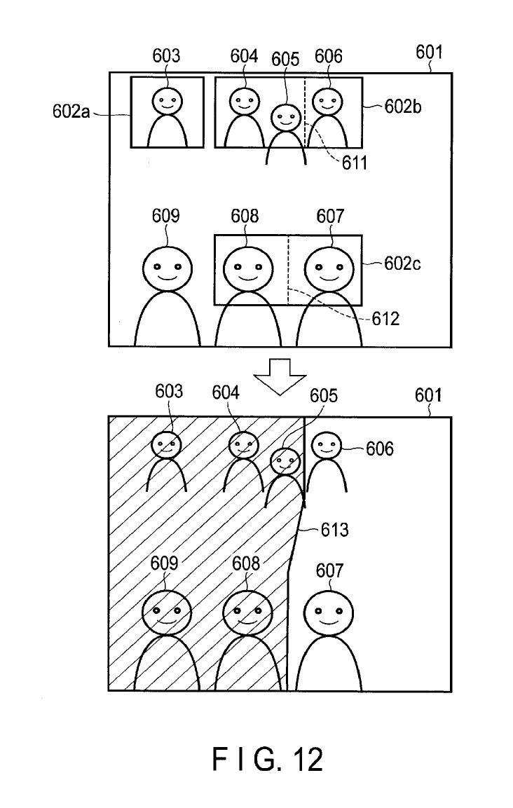

Now, this specification specifically explains the second parameter adjustment process in a case where detection unnecessary people are specified based on the positions of people with reference to FIG. 12. When detection unnecessary people are specified based on the positions of people, the user specifies a mode for setting the area. The mode for setting the area is a mode for adjusting (setting) a parameter related to the target area of a human detection process in an image. In FIG. 12, for the sake of convenience, the background is omitted, and people are schematically illustrated in a manner similar to that of FIG. 10 and FIG. 11.

In the second parameter adjustment process, for example, a plurality of visual confirmation ranges may be displayed such that the desired number of people to be detected is input for each of the visual confirmation ranges. It is assumed that an image 601 and a plurality of visual confirmation ranges 602a to 602c are displayed in the second parameter adjustment process.

Specifically, as shown in the upper stage of FIG. 12, the visual confirmation range 602a of the image 601 includes a person 603. The visual confirmation range 602b of the image 601 includes people 604 to 606. The visual confirmation range 602c includes people 607 and 608.

It is assumed that “0”, “1” and “1” are input as the desired number of people to be detected for the visual confirmation ranges 602a, 602b and 602c, respectively. In this case, the person 603 detected in the visual confirmation range 602a is specified as a detection unnecessary person.

In the visual confirmation range 602b, the people 604 to 606 are detected. When the desired number of people to be detected is one as described above, the number of detection unnecessary people is two. In this case, of the people 604 to 606, for example, the two people 604 and 605 close to the visual confirmation range 602a in which the desired number of people to be detected is zero are specified as detection unnecessary people. For example, when the image does not include any visual confirmation range in which the desired number of people to be detected is zero, people located far from the center of the image may be specified as detection unnecessary people. Similarly, in the visual confirmation range 602c, of the people 607 and 608 detected in the visual confirmation range 602c, the person 608 close to the visual confirmation range 602a is specified as a detection unnecessary person.

In this case, for example, the parameter for restricting the target area of a human detection process in the image (in other words, a parameter related to detection unnecessary people) is adjusted (set) such that none of the people 603 to 605 and 608 specified as detection unnecessary people is detected.

Specifically, as shown in the upper stage of FIG. 12, for example, a boundary line 611 is generated between the area including the people 604 and 605 specified as detection unnecessary people in the visual confirmation range 602b and the other person 606 present in the visual confirmation range 602b. Similarly, a boundary line 612 is generated between the person 608 specified as a detection unnecessary person in the visual confirmation range 602c and the other person 607 present in the visual confirmation range 602c. By connecting the boundary lines 611 and 612 generated in the above manner, for example, a boundary line 613 is generated as shown in the lower stage of FIG. 12. The boundary line 613 is a line for separating (the area including) the people 603 to 605 and 608 specified as detection unnecessary people from (the area including) the people 606 and 607 who are not specified as detection unnecessary people.

In this way, it is possible to adjust the parameter for restricting the target area of a human detection process in the image such that, of the two areas separated by the boundary line 613, the area including detection unnecessary people (specifically, the area indicated with hatching in the lower stage of FIG. 12) is set as an area excluded from the target of the human detection process.

When a human detection process is applied to the image 601 after the above adjustment of the parameter, a person 609 present in the left area of the boundary line 613 is not detected in addition to the people 603 to 605 and 608 specified as detection unnecessary people.

When detection unnecessary people are specified based on the positions of people as described above, the parameter may be adjusted such that none of the persons 603 to 605, 608 and 609 is detected based on the desired number of people to be detected input by the user.

In the above explanation, a plurality of visual confirmation ranges 602a to 602c are displayed. However, when detection unnecessary people are specified based on the positions of people, only one visual confirmation range may be displayed.

As explained above, the parameters related to detection unnecessary people can be adjusted when the user specifies, for example, the mode for setting the lower limit of the size, the mode for setting the upper limit of the size, the mode for setting the lower limit of the brightness, the mode for setting the upper limit of the brightness and the mode for setting the area. In other words, the parameter to be adjusted may be changed based on the setting mode.

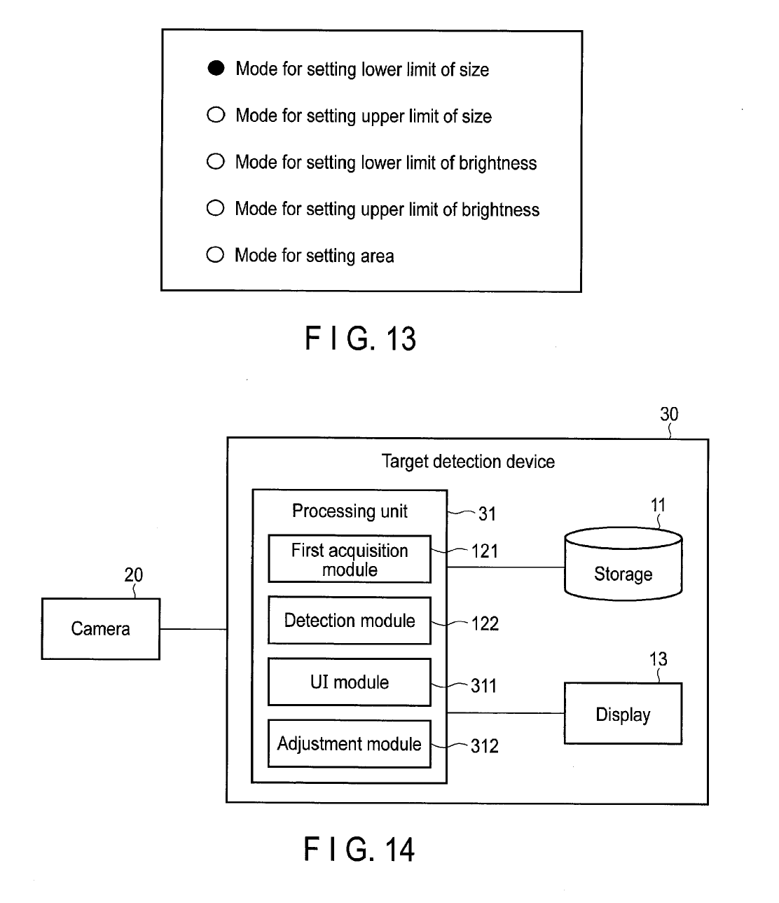

For example, each setting mode (the information related to each setting mode) can be specified (selected) by the user when each mode is displayed on the setting screen shown in FIG. 13. FIG. 13 assumes that the mode for setting the lower limit of the size is specified.

In the above explanation, detection unnecessary people are specified based on the brightness (or contrast ratio) or position. However, detection unnecessary people may be specified based on other conditions (standards).

The visual confirmation range in the second parameter adjustment process needs to be a range including detection unnecessary people. Thus, in step S4, the range (first range) specified by the user is determined as the visual confirmation range.

When the second parameter adjustment process is performed in addition to the first parameter adjustment process as described above, the parameters are adjusted such that only the desired people for the user are detected. Thus, the human detection intended by the user can be realized in the future human detection process.

As described above, in the present embodiment, an image including more than one person (more than one target to be detected) is acquired, more than one person included in the image are detected in accordance with the parameters set in advance, visual confirmation information related to the people included in the image and visually confirmed by the user is acquired, and the parameters are adjusted based on the result of detection and the visual confirmation information.

In the present embodiment, by such a configuration, the parameters used to detect the target can be easily adjusted.

Specifically, in the present embodiment, the visual confirmation information includes the number of people included in a specific range (visual confirmation range) of an image. In the present embodiment, the parameters are adjusted such that the number of people detected in the visual confirmation range is equal to the number of people included in the visual confirmation information. The parameters adjusted in the present embodiment include, for example, the parameter related to the size of the people to be detected from images (in other words, the detection size parameter).

In the present embodiment, by such a configuration, when the user merely inputs (specifies) the number of people present in the visual confirmation range included in the displayed image, the parameters are adjusted (changed) so as to improve the detectability of the people. Thus, the user does not need to conduct any complicated operation to adjust the parameters.

In the present embodiment, the second parameter adjustment process is performed in addition to the first parameter adjustment process as described above. Thus, in addition to the detection size parameter, the other parameters can be adjusted.

In the present embodiment, people are detected from images. For example, the entire bodies, heads or faces of people may be detected from images. Although the target to be detected is a person in the present embodiment, the target to be detected may be, for example, an animal or another object (moving object). A known detection technology using statistical learning, etc., may be employed to detect the target.

In the present embodiment, the target detection device 10 is connected to the camera 20. However, the camera 20 may be incorporated into the target detection device 10.

Moreover, in the present embodiment, the target detection device 10 is explained as a single device. However, for example, the target detection device 10 may be realized by a plurality of devices. Thus, the modules 121 to 125 included in the above processing unit 12 may be dispersed into the plurality of devices.

### Second Embodiment

A second embodiment is explained. FIG. 14 is a block diagram showing an example of the configuration of a target detection device according to the present embodiment. In FIG. 14, the same elements as those of FIG. 1 are denoted by like reference numbers, detailed description thereof being omitted. Elements different from those of FIG. 1 are mainly explained.

In the present embodiment, a user interface (UI) is provided to adjust the parameters used to detect people. In this respect, the present embodiment is different from the first embodiment.

As shown in FIG. 14, a target detection device 30 includes a processing unit 31. The processing unit 31 is realized by a computer provided in the target detection device 30 and executing a program stored in the storage device or the memory device. The processing unit 31 includes a processor and the like connected to the storage device and the memory device.

In addition to the first acquisition module 121 and the detection module 122 explained in the first embodiment, the processing unit 31 includes a user interface module (UI module) 311 and an adjustment module 312.

The UI module 311 displays a user interface for receiving user's operation on a display 13 when the parameters used to detect people are adjusted.

The adjustment module 312 adjusts the parameters set in a setting file in accordance with the user's operation for the user interface displayed on the display 13 by the UI module 311.

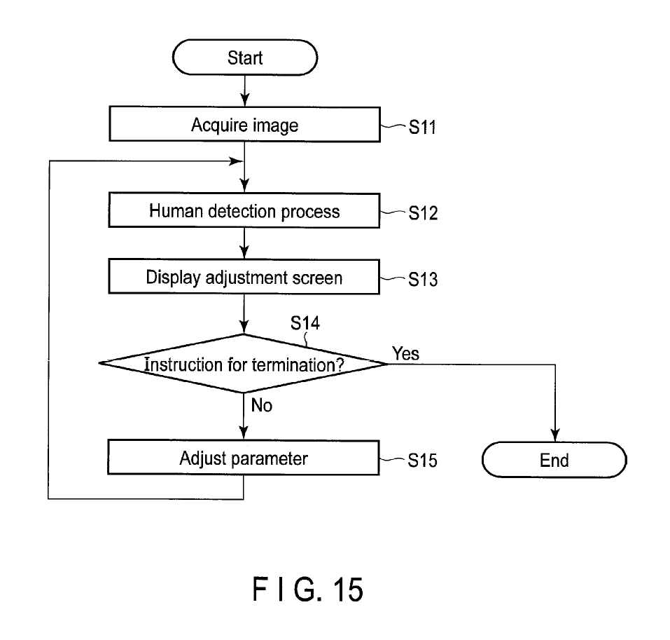

With reference to the flowchart of FIG. 15, this specification explains an example of the procedure of a parameter adjustment process performed by the target detection device 30 of the present embodiment. In the following description, this specification explains a process for adjusting a parameter related to the size of people to be detected from images (in other words, a detection size parameter). The process shown in FIG. 15 is performed when, for example, the user of the target detection device 30 instructs the device to perform a parameter adjustment process.

The process of steps S11 and S12 equivalent to that of steps S1 and S2 shown in FIG. 7 is performed.

Subsequently, the UI module 311 displays a screen for allowing the user to adjust the parameter (hereinafter, referred to as an adjustment screen) on the display 13 (step S13). The adjustment screen includes the image acquired in step S11 and the result of detection of step S12. Further, a user interface for receiving the user's operation is displayed on the image acquired in step S11 on the adjustment screen.

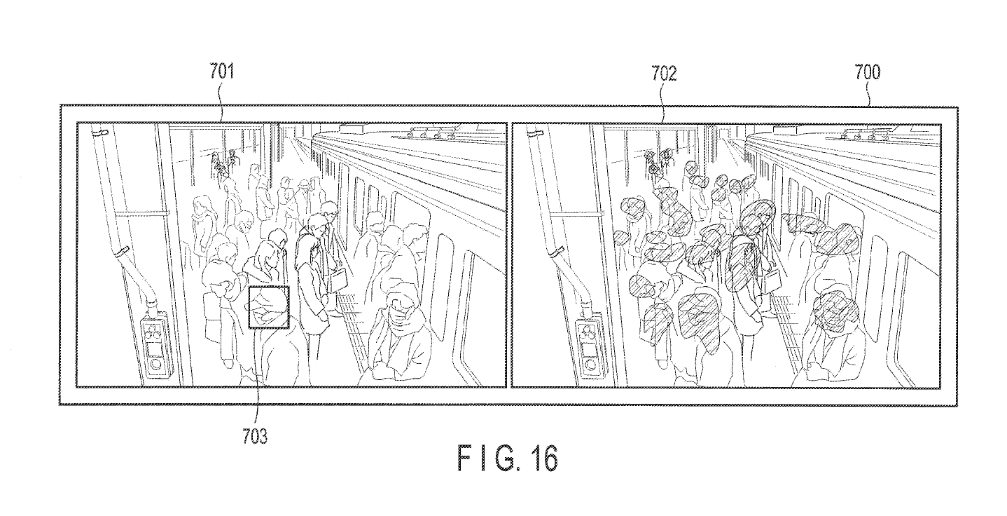

Now, this specification specifically explains the adjustment screen, referring to FIG. 16. As shown in FIG. 16, an adjustment screen 700 includes an image 701 and (the image of) the result of detection 702. The user is able to recognize the result of the human detection process for the image 701 (that is, the result of detection 702) by confirming the adjustment screen 700.

A rectangular frame 703 is displayed as a user interface (user interface 703) on the image 701. For example, the user interface 703 indicates the size of the person (specifically, the head of the person) detected in accordance with the detection size parameter. In other words, for example, the user interface 703 indicates a size applicable between the lower and upper limits defined in the detection size parameter. The user is able to recognize the size of the person detected from the image by (the size indicated by) the user interface 703. For example, the position of the user interface 703 on the image 701 is specified by the user.

The user determines whether or not the parameter needs to be adjusted by confirming the adjustment screen 700 (specifically, the image 701 and the result of detection 702 included in the adjustment screen 700). Whether or not the parameter needs to be adjusted may be determined by, for example, comparing the size indicated by the user interface 703 with the size of people near the user interface 703. When the size indicated by the user interface 703 is very different from that of people near the user interface 703, the user may determine that the parameter needs to be adjusted.

When the user determines that there is no need to adjust the parameter, the user is able to instruct the device to terminate the parameter adjustment process by, for example, pressing a termination button (not shown) provided on the adjustment screen 700.

On the other hand, when the user determines that the parameter needs to be adjusted, the user may adjust the parameter by operating the user interface 703 displayed on the screen 701. The operation for the user interface 703 is received by the UI module 311.

The operation for the user interface 703 includes an operation of enlarging or shrinking the user interface 703 (in other words, increasing or decreasing the size indicated by the user interface 703). Specifically, for example, when the size of the people (specifically, the head of each person) included in the image is larger than the size indicated by the user interface 703, the user enlarges the user interface 703 to the extent that the size indicated by the user interface 703 is substantially equal to the size of the people included in the image. When the size of the people (specifically, the head of each person) included in the image is smaller than the size indicated by the user interface 703, the user shrinks the user interface 703 to the extent that the size indicated by the user interface 703 is substantially equal to the size of the people included in the image.

The operation for the user interface 703 may be, for example, an operation using a mouse, an operation of pressing a specific key provided in a keyboard, or other operations.

The target detection device 30 determines whether or not an instruction that the parameter adjustment process should be terminated is issued based on the user's operation (step S14).

When the operation for the user interface 703 is performed by the user, the target detection device 30 determines that an instruction that the parameter adjustment process should be terminated is not issued in step S14 (NO in step S14).

In this case, the adjustment module 312 adjusts the parameter based on the operation for the user interface 703 received by the UI module 311 (step S15). Specifically, when the operation received by the UI module 311 is an operation of enlarging the user interface 703, for example, the adjustment module 312 adjusts the upper limit (and the lower limit) defined in the detection size parameter upward (in other words, increases the values). When the operation received by the UI module 311 is an operation of shrinking the user interface 703, for example, the adjustment module 312 adjusts the lower limit (and the upper limit) defined in the detection size parameter downward (in other words, decreases the values).

The amount of adjustment of the detection size parameter (the upper and lower limits) is determined based on, for example, the enlargement ratio, the reduction ratio, etc., of the size indicated by the user interface 703.

When the parameter is adjusted in step S15, the process returns to step S12 and repeats the steps. In this case, the human detection process in step S12 is performed in accordance with the parameter adjusted in step S15. In this way, in step S13, the adjustment screen 700 including the result of detection 702 of the human detection process performed in accordance with the adjusted parameter is displayed.

Thus, every time the parameter is adjusted in step S15, the user is able to recognize the change in the result of the human detection process based on the adjustment. In other words, the user is able to adjust the parameter so to be appropriate values by repeatedly operating the user interface 703 until the desired result of detection is obtained (displayed).

When the desired result of detection is obtained, the user is able to instruct the device to terminate the parameter adjustment process as described above.

In this case, the target detection device 30 determines that an instruction that the parameter adjustment process should be terminated is issued in step S14 (YES in step S14). Thus, the process is terminated.

In the above explanation of FIG. 15, this specification assumes a case where the detection size parameter is adjusted. However, for example, an area including a detection unnecessary person in the image may be specified by a mouse, etc., on the adjustment screen. Thus, a parameter for restricting the target area of the human detection process (in other words, a parameter related to detection unnecessary people) may be adjusted (set).

As stated above, in the present embodiment, the user interface 703 indicating the size of a person (target) detected from the image in accordance with the parameter is displayed on the image. The parameter is adjusted in accordance with the user's operation for the user interface 703.

In the present embodiment, by such a configuration, the parameter can be adjusted (changed) so as to improve the detectability of the target by merely enlarging or shrinking the user interface 703 (in other words, increasing or decreasing the size indicated by the user interface 703) with reference to the size of the people included in the image.

For example, when the image 701 and the user interface 703 shown in FIG. 16 are displayed (specifically, the adjustment screen including the image 701 and the user interface 703 is displayed), the parameter may be adjusted. However, in the present embodiment, the result of detection 702 by a human detection process is further displayed. Thus, the user is able to operate the user interface 703 while confirming the result of detection 702 (specifically, the change in the result of detection 702). Thus, the user can more effectively adjust the parameter.

According to at least one of the above embodiments, it is possible to provide an information processing device, a method and a storage medium capable of accurately detecting the target.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a storage device; and
a processor connected to the storage device,
wherein the processor is configured to:
perform a process for displaying a first image and information indicating a partial area of the first image;
acquire information related to a target in the partial area; and
detect a target from at least one of the first image and a second image different from the first image based on the information related to the target.

2. The information processing device of claim 1, wherein
the processor is configured to detect a target from at least one of the first image and the second image based on a first result of detection for the partial area of the first image and the information related to the target.

3. The information processing device of claim 2, wherein
the processor is configured to determine a parameter used for detection based on the first result of detection and the information related to the target.

4. The information processing device of claim 3, wherein
the processor is configured to determine the parameter such that the first result of detection conforms to the information related to the target.

5. The information processing device of claim 3, wherein
the processor is configured to determine the parameter used to detect a target in an area other than an area corresponding to the partial area.

6. The information processing device of claim 3, wherein
the parameter is a parameter related to a size of a target.

7. The information processing device of claim 3, wherein
the processor is configured to change the parameter to be determined based on a setting mode.

8. The information processing device of claim 1, wherein
the processor is configured to perform a process for displaying information related to the setting mode.

9. The information processing device of claim 1, wherein
the information related to the target is a number of targets included in the partial area.

10. The information processing device of claim 1, wherein
the information related to the target is information input by a user.

11. The information processing device of claim 1, further comprising a display which displays the first image and information indicating the partial area of the first image.

12. The information processing device of claim 1, wherein
the processor is configured to select an area which does not include a target as the partial area of the first image.

13. A non-transitory computer-readable storage medium having stored thereon a computer program which is executable by a computer, the computer program comprising instructions capable of causing the computer to execute functions of:
performing a process for displaying a first image and information related to a partial area of the first image;
acquiring information related to a target included in the partial area; and
detecting a target from at least one of the first image and a second image different from the first image based on the information related to the target.

14. A method comprising:
performing a process for displaying a first image and information indicating a partial area of the first image;
acquiring information related to a target included in the partial area; and
detecting a target from at least one of the first image and a second image different from the first image based on the information related to the target.

15. The method of claim 14, wherein
the detecting comprises detecting a target from at least one of the first image and the second image based on a first result of detection for the partial area of the first image and the information related to the target.

16. The method of claim 15, wherein
the detecting comprises determining a parameter used for detection based on the first result of detection and the information related to the target.

17. The method of claim 16, wherein
the determining comprises determining the parameter such that the first result of detection conforms to the information related to the target.

18. The method of claim 16, wherein
the determining comprises determining the parameter used to detect a target in an area other than an area corresponding to the partial area.

19. The method of claim 16, wherein
the parameter is a parameter related to a size of a target.

20. The method of claim 16, further comprising changing the parameter to be determined based on a setting mode.
